(19) United States
(12) Patent Application Publication
(10) Pub. No.: US 2007/0194644 A1
(43) Pub. Date: Aug. 23, 2007

(54) SPINDLE MOTOR

(75) Inventors: Tadayuki KANATANI, Kyoto (JP); Satoshi UEDA, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/677,113

(22) Filed: Feb. 21, 2007

(30) Foreign Application Priority Data
Feb. 22, 2006 (JP) 2006-046050

(51) Int. Cl. H02K 5/16; H02K 7/08; F16C 33/72

(52) U.S. Cl. 310/90; 384/94

(57) ABSTRACT

In a motor arranged to rotate a color wheel of a projector unit, a rotor yoke is fixed to a rotor hub by crimping the entire circumference thereof in order to prevent lubricating oil from leaking to the outside of the motor. A joint portion between the rotor yoke and the rotor hub is sealed with a sealant, such as an adhesive, to securely seal the joint portion.

### BACKGROUND OF THE INVENTION

1. Field of the Invention

The present invention generally relates to a spindle motor which has a sleeve arranged within a hollow cylindrical portion of a housing and rotatably supporting a shaft via lubricating oil, and more particularly, to a spindle motor which has a structure to prevent the lubricating oil from leaking to the outside of the spindle motor.

2. Description of the Related Art

A spindle motor (hereinafter simply referred to as a motor) which has a sleeve arranged within a hollow cylindrical portion of a housing and rotatably supporting a shaft via lubricating oil is used as a driving motor of various devices such as a recording disk driving device and a color wheel driving device installed in a single-plate type projector unit using Digital Light Processing (DLP).

The motor generally includes a sleeve made of sintered alloy in which the lubricating oil is impregnated. If the lubricating oil leaks to the outside of the hollow cylindrical portion, an adequate amount of the lubricating oil is not maintained between the sleeve and the shaft, which degenerates bearing performance and shortens bearing life. In addition, leaked lubricating oil attached to the recording disk and the color wheel adversely affects their performance. Therefore, the motor generally has a structure to prevent the lubricating oil from leaking from the hollow cylindrical portion.

Japanese published unexamined utility model, JP H11-252878 discloses a motor having a structure which prevents a rotor unit including a shaft from being removed from a stator unit including a sleeve. The motor includes a bias magnet and a magnetic member attracted to each other, wherein one is arranged on the rotor unit and the other is arranged on the stator unit such that they are axially attracted each other. The outer circumferential surface of a ring member is attached to the rotor unit such that a radially inner circumferential surface faces the stator unit with a gap defined therebetween. The gap is configured to have a narrow width to prevent the lubricating oil from leaking therethrough.

FIG. 6 is a cross sectional view illustrating another example of a conventional motor. In this example, a rotor yoke 103 is fixed to a rotor hub 101 by multiple point crimping. A flange portion 103a extending radially inwardly from an upper end portion of the rotor yoke 103 is engaged with an annular convex portion 101a arranged at a bottom surface of the rotor hub 101. The convex portion 101a is deformed radially outwardly such that the flange portion 103a is sandwiched between the tip end of the annular convex portion 101a and the bottom surface of the rotor hub 101. An oil-shield washer 122 is arranged on a sleeve 105 to prevent the lubricating oil from leaking.

In such conventional motors, once the lubricating oil leaks from the upper opening of the hollow cylindrical portion, the lubricating oil may diffuse across gaps between the rotor hub and the rotor yoke, and leak to the outside of the motor. The lubricating oil leaked to the outside the motor may stain the color wheel and degenerate the performance of the projector unit.

A sealant such as a UV curable adhesive may be applied to seal the gap between the rotor yoke and the rotor hub. However, the adhesive may diffuse from the gap between the rotor hub and the rotor yoke without hardening.

### SUMMARY OF THE INVENTION

In order to overcome the problems described above, preferred embodiments of the present invention provide a motor including a rotor unit rotating about a rotational axis and a stator unit rotatably supporting the rotor unit. The rotor unit includes a rotor hub having a substantially circular shape centered on the rotational axis, a shaft concentric with the rotor hub and attached to a substantially middle portion of the rotor hub, a rotor yoke having a substantially hollow cylindrical shape concentric to the shaft, and a rotor magnet arranged at an inner circumferential surface of the rotor yoke. The stator unit includes a stator unit rotatably supporting the rotor unit and including a sleeve having a substantially hollow cylindrical shape concentric with the rotational axis, and being a part of the stator unit and impregnated with lubricating oil to rotatably support the shaft, and a stator being a part of the stator unit and facing the rotor magnet. In the motor, an entire circumference of an axially end portion of the rotor yoke is crimped to an outer circumferential portion of the rotor hub. Then, a sealant is applied to a portion of the rotor unit where the rotor yoke is crimped to the rotor hub.

Through the configuration described above, a portion of the rotor hub where the rotor yoke is crimped to the rotor hub is securely sealed and, thus, lubricating oil leaking from the portion to the outside of the motor is prevented.

The motor according to a preferred embodiment of the present inventions preferably includes a bias magnet and a ring member made of magnetic material. The attraction force between the bias magnet and the ring member prevents the rotor unit from being removed from the stator unit. Either of the bias magnet or the ring member is arranged near an axial end portion of the sleeve, and an inner circumferential surface of at least one of the ring member and the bias magnet radially faces the shaft. Through this configuration, lubricating oil leaking from the sleeve is prevented.

Other features, elements, steps, processes, characteristics and advantages of the present invention will become more apparent from the following detailed description of preferred embodiments of the present invention with reference to the attached drawings.

### BRIEF DESCRIPTION OF THE DRAWINGS

FIG. 1 is a cross sectional view illustrating a motor according to a preferred embodiment of the present invention.

FIG. 2A is a cross sectional view illustrating a joint portion at which a rotor hub and a rotor yoke are joined.

FIG. 2B is a bottom plan view illustrating the joint portion at which the rotor hub and the rotor yoke are joined.

FIG. 2C is a bottom plan view illustrating a joint portion of a conventional motor at which a rotor yoke and a housing are crimped at multiple locations.

FIG. 3 is a cross sectional view illustrating a motor according to a second preferred embodiment of the present invention.

FIG. 4 is a cross sectional view illustrating a motor according to a third preferred embodiment of the present invention.

FIG. 5 is a schematic view illustrating a projector unit according to a preferred embodiment of the present invention.

FIG. 6 is across sectional view illustrating a conventional motor.

### DETAILED DESCRIPTION OF PREFERRED EMBODIMENTS

It should be understood that in the description of preferred embodiments of the present invention, when positional relationships among and orientations of the different components are described as being such as top/bottom, up/down, left/right or the like, positional relationships and orientations which are in the drawings are indicated, and positional relationships among and orientations of the components once having been assembled into an actual device are not indicated. Additionally, in the following description, an axial direction indicates a direction parallel to a rotation axis, and a radial direction indicates a direction perpendicular to and centered about the rotation axis.

### First Preferred Embodiment

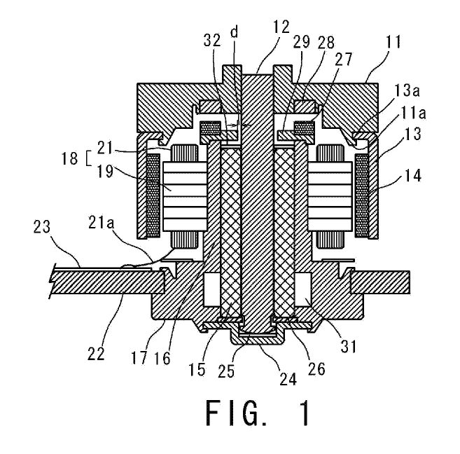

FIG. 1 is a cross sectional view of a spindle motor (hereinafter simply referred to as a motor) according to a first preferred embodiment of the present invention. The motor may be used for a single-plate type projector unit using Digital Light Processing (DLP) to rotate a color wheel of the projector unit. The motor includes a rotor unit and a stator unit. The rotor unit has a rotor hub 11 to which the color wheel may be mounted, a shaft 12 attached to substantially the middle of the rotor hub 11, a rotor yoke 13 having a hollow cylindrical shape concentric to the shaft 12 and attached to an outer circumferential portion of a bottom surface of the rotor hub 11, and a rotor magnet 14 attached to an inner circumferential surface of the rotor yoke 13. The rotor hub 11 is preferably made of aluminum, and an upper surface thereof includes a color wheel placing portion defined by a flat surface substantially perpendicular to a rotational axis. The color wheel is arranged at the placing portion in a manner such that a bottom surface of the color wheel abuts against the placing portion.

The stator unit includes a sleeve 15 rotatably supporting the shaft 12 via lubricating oil, a housing 17 having a hollow cylindrical portion 16 accommodating the sleeve 15, and a stator 18 attached to an outer circumferential surface of the hollow cylindrical portion 16 such that an outer circumferential surface faces an inner circumferential surface of the rotor magnet 14 with a gap defined therebetween.

The stator 18 is defined by a stator core 19, a laminated body of magnetic metal plates, and a plurality of coils 21 formed by winding wires around portions of the stator core 19 and coated with an insulating material. A bottom end portion of the housing 17 fits into a bore arranged in a base plate 22 to fix the housing 17 to the base plate 22. A flexible printed circuit (FPC) 23 is arranged on an upper surface of the base plate 22, and lead wires 21a of coils 21 are preferably connected to the FPC 23 by soldering.

A bottom opening of the housing 17 is closed by attaching a cap 24, at a middle of which a plastic or resin plate 25 defining a thrust bearing is arranged, to support the bottom surface of the shaft 12. A ring-shaped retaining member 26 is arranged axially between a bottom end surface of the sleeve 15 and an upper surface of the cap 24. A radially inner end portion of the retaining member 26 is arranged in a first annular groove arranged at a bottom portion of the shaft 12. A bottom surface of the housing 17 includes an annular protrusion which is radially inwardly deformed such that the cap 24 is fixed in a sandwiched manner between the annular protrusion and the bottom surface of the housing 17. A sealant (e.g., adhesive, resin and the like) is applied to a joint between the cap 24 and the housing 17 such that the lubricating oil does not leak from the joint. However, the cap 24 may be fixed to the housing 17 by other techniques, such as laser welding and the like.

In addition to the retaining member 26, the motor includes a bias magnet 27 and a ring-shaped magnetic member 28 (ring member 28) attracted to each other to prevent the rotor unit from being removed from the stator unit. One of the bias magnet 27 and the ring member 28 is arranged on the rotor unit and the other is arranged on the stator unit. The bias magnet 27 is arranged in a manner axially facing the ring member 28, and due to the attraction force therebetween, the rotor unit is not easily removed from the stator unit.

The bias magnet 27 is arranged at an axially upper end portion of the hollow cylindrical portion 16 of the housing 17 via a back yoke 29. The ring member 28 fits into a second annular groove arranged in a bottom surface of the rotor hub 11. The back yoke 29 prevents the lubricating oil from leaking (described later) and makes the magnetic flux flow smoothly.

The sleeve 15 is preferably made of sintered alloy and is arranged within the hollow cylindrical portion 16 of the housing 17. A third annular groove is arranged at a lower portion of an inner circumferential surface of the hollow cylindrical portion 16, and an oil supply member 31 (an annular felt member 31 in this preferred embodiment of the present invention) impregnated with lubricating oil is arranged within the third annular groove. The lubricating oil held by the felt member 31 moves to an outer circumference of the sleeve 15, diffuses across the sleeve 15, and then moves to an inner circumference of the sleeve 15. The lubricating oil moved to the inner circumference of the sleeve 15 forms an oil film between an outer circumference of the shaft 12 and the inner circumference of the sleeve 15.

The bottom opening of the housing 17 is closed by the cap 24, but an upper opening thereof is left open, thus, the lubricating oil may leak from the upper opening. In order to prevent the lubricating oil from leaking, an annular member 32 (e.g., an oil-shield washer) is arranged at an upper end surface of the sleeve 15, and the amount of the lubricating oil impregnated to the felt member 31 and the sleeve 15 is controlled precisely.

Additionally, a radially inner circumferential surface of the back yoke 29 faces a radially outer circumferential surface of the shaft 12 with a minute gap d defined therebetween. Through this configuration, the lubricating oil leaking upwardly is blocked by the back yoke 29 and is returned to the sleeve 15.

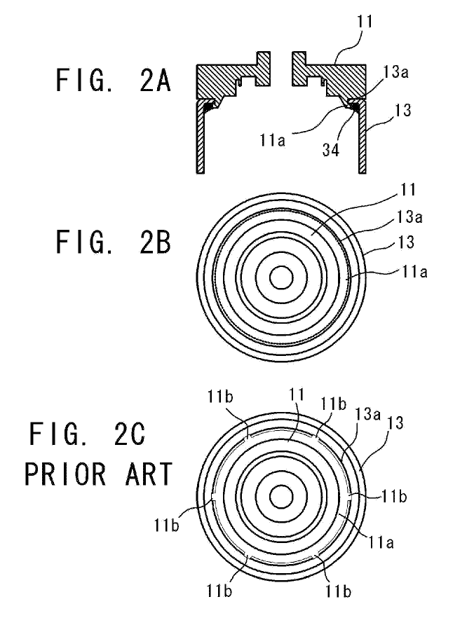

The rotor yoke 13 is fixed to the rotor hub 11 along the entire inner circumference of a flange portion 13a extending radially inwardly from the upper end portion of the rotor yoke 13 by crimping (i.e., entire circumference crimping). In addition, the adhesive is applied over a joint portion at which the rotor yoke 13 and the rotor hub 11 are joined such that the joint portion is sealed securely. With this configuration, even if the lubricating oil leaks upwardly from the upper opening of the housing 17, it does not diffuse across the joint portion, thus, the lubricating oil does not leak to the outside of the motor. FIG. 2A is a cross sectional view illustrating the joint portion at which the rotor hub 11 and the rotor yoke 13 are joined. FIG. 2B is a bottom plan view illustrating the joint portion. FIG. 2C is a bottom plan view illustrating the joint portion according to the conventional art in which the rotor yoke 13 and the housing 11 are crimped at multiple locations in a circumferentially spaced manner.

As illustrated in FIGS. 2A and 2B, the rotor yoke 13 includes the flange portion 13a extending radially inwardly from an upper end portion of the rotor yoke 13. Moreover, an annular convex portion 11a is arranged on the bottom surface of the rotor hub 11. Upon fixing the rotor yoke 13 to the rotor hub 11, the upper end portion of the rotor yoke 13 abuts against the radially outside portion of the bottom surface of the rotor hub 11, and an inner circumferential end surface of the flange portion 13a abuts against an outer circumferential surface of the annular convex portion 11a. Additionally, an axial end portion of the annular convex portion 11a is radially outwardly deformed along the entire circumference thereof such that the rotor yoke 13 is sandwiched and fixed between the annular convex portion 11a and the bottom surface of the rotor hub 11. Finally, a UV curable adhesive 34 is applied and hardened along the entire circumference. Through the configuration described above, the joint portion of the rotor yoke 13 and the rotor hub 11 is securely sealed.

In the conventional art illustrated in FIG. 2C, the axial end portion of the annular convex portion 11a is radially outwardly deformed at only six portions 11b arranged circumferentially at every sixty degrees. In other words, there are gaps between the rotor yoke 13 and the rotor hub 11 at portions other than the six portions 11b. When the UV curable adhesive 34 is applied to the portions 11b, the adhesive diffuses across the gaps and is not hardened. Thus, the gap defined between the inner end surface of the flange portion 13a of the rotor yoke 13 and the rotor hub 11 is not securely sealed.

In the first preferred embodiment of the present invention as illustrated in FIG. 2B, in which the rotor yoke 13 and the annular convex portion 11a are fixed along the entire circumference by crimping, it is less likely that gaps are formed between the inner end surface of the flange portion 13a and the annular convex portion 11a, and the UV curable adhesive does not diffuse therebetween. Thus, the joint portion of the rotor yoke 13 and the rotor hub 11 is securely sealed. In addition, by applying the entire circumference crimping, the rotor yoke 13 is fixed to the rotor hub 11 with a greater joint strength than that of the conventional art.

It is preferable to use a UV curable adhesive as it has a short cure time and only requires a small-scale facility. It should be noted, however, thermosetting adhesive may be used to seal the joint portion of the rotor yoke 13 and the rotor hub 11. Instead of using an adhesive, resin, paint or other coating materials may be used to seal the joint portion. Alternatively, the rotor yoke 13 may be welded to the rotor hub 11 by radiating with a high density energy beam (e.g., a laser beam) such that the joint portion is securely sealed.

According to the first preferred embodiment of the present invention described above, the rotor yoke 13 is fixed to the rotor hub 11 along the entire circumference thereof by crimping, and preferably including an adhesive, and the inner circumferential surface of the back yoke 29 faces the shaft 12 with the minute gap d defined therebetween. Through this configuration, the lubricating oil will be prevented from leaking to the outside of the motor. In addition to the back yoke 29, the bias magnet 27 may have an inner circumferential surface facing the shaft 12 with a minute gap defined therebetween. The gap between the bias magnet 27 and the shaft 12 may have a width smaller than the gap between the shaft 12 and the back yoke 29 to more effectively prevent oil leakage.

The bias magnet 27 may switch its position with the ring member 28. Specifically, the bias magnet 27 may be arranged at the bottom surface of the rotor hub 11, and the ring member 28 may be arranged at the upper end portion of the hollow cylindrical portion 16 of the housing 17 via the back yoke 29.

### Second Preferred Embodiment

In a second preferred embodiment of the present invention, the inner circumferential surface of the bias magnet 27 directly arranged on the hollow cylindrical portion 16 faces the shaft 12 with the minute gap d defined therebetween.

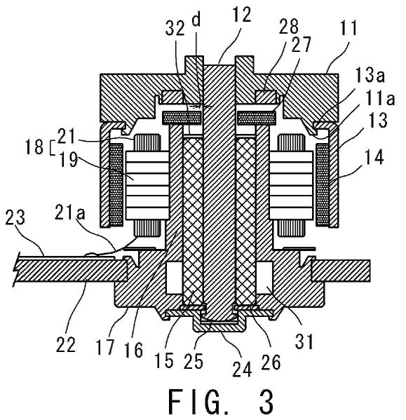

FIG. 3 is a cross sectional view illustrating the motor according to the second preferred embodiment of the present invention. In the motor illustrated FIG. 3, the bias magnet 27 is arranged directly on the upper end portion of the hollow cylindrical portion 16 directly (e.g., the motor does not include a back yoke). The inner circumferential surface of the bias magnet 27 faces the shaft 12 with the minute gap d defined therebetween. With this configuration, a bottom surface of the bias magnet 27 will prevent the lubricating oil from leaking axially upwardly from the upper opening of the cylindrical portion 16 of the housing 17. The rest of the configuration is the same as that depicted above and is labeled with the same reference numerals.

The bias magnet 27 may switch its position with the ring member 28. Specifically, the bias magnet 27 may be arranged at the bottom surface of the rotor hub 11, and the ring member 28 may be arranged at the upper end portion of the hollow cylindrical portion 16 of the housing 17. In this case, an inner circumferential surface of the ring member 28 may face the shaft 12 with the minute gap d defined therebetween to prevent the lubricating oil from leaking axially upwardly.

### Third Preferred Embodiment

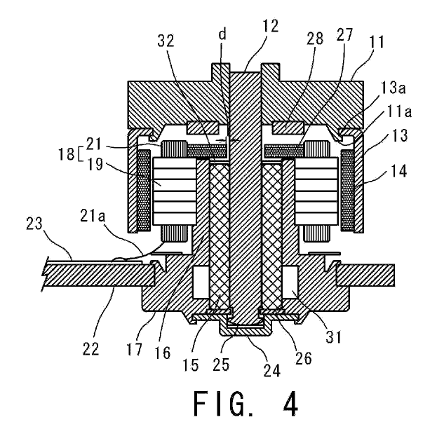

FIG. 4 is a cross sectional view illustrating the motor according to a third preferred embodiment of the present invention. In the third preferred embodiment of the present invention, the bias magnet 27 is arranged on the stator 18. The rest of the configuration is the same as that depicted in the second preferred embodiment of the present invention and is labeled with the same reference numerals. With this configuration, a bottom surface of the bias magnet 27 will prevent the lubricating oil from leaking axially upwardly from the upper opening of the hollow cylindrical portion 16 of the housing 17.

The bias magnet 27 may switch its position with the ring member 28. Specifically, the bias magnet 27 may be arranged either at the bottom surface of the rotor hub 11 or at the upper end portion of the stator 18.

The bias magnet 27 or the ring member 28 provided on the stator unit may be fixed to the stator unit via another member. For example, the back yoke may be arranged on the stator 18 and the bias magnet or the ring member may be attached to the stator 18 via the back yoke.

### Projector Unit

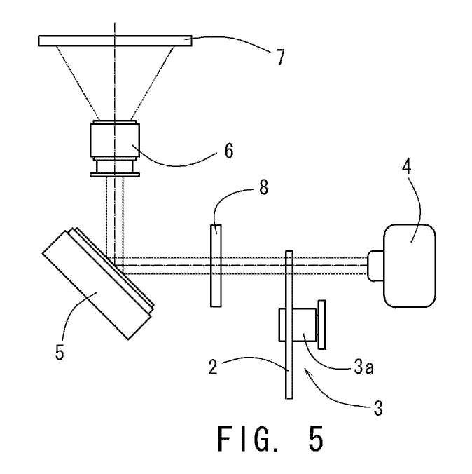

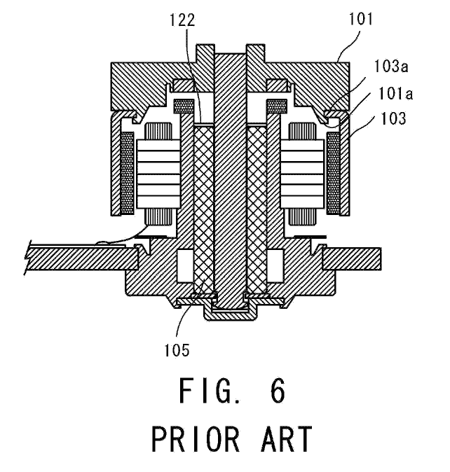

FIG. 5 is a schematic view illustrating a projector unit according to a preferred embodiment of the present invention.

The projector unit preferably includes a color wheel assembly 3, a light source 4, a digital micro mirror device (DMD) 5, and a projection assembly 6. The color wheel assembly 3 includes a later-described motor 3a and a color wheel 2 attached to a rotor unit of the motor 3a. The light source 4 irradiates light onto the color wheel 2, and the light passing through the color wheel 3 is reflected by the DMD 5. The light reflected by the DMD 5 is guided to the projection assembly 6 which projects the image on a screen 7.

For example, the color wheel 2 includes three different filters, the first one (R filter) passes the light in a red band in a spectrum (R), the second one (G filter) passes the light in a green band (G), and the third one (B filter) passes the light in a blue band (B). The color wheel 3 is circumferentially divided into three areas by 120 degrees, at which the R, G and B filters are arranged. The color wheel 3 is rotated by the motor 3a at about 7,200 RPM to about 14,400 RPM. DMD 5 includes a plurality of micro reflecting mirrors which are attitude-controllable and arranged in a two dimensional manner. Either one of R, G, and B light passing through the color wheel 2 is guided to the DMD 5 through a condenser lens 8 and is reflected to the projection assembly 6 or in another direction such that the light coming into the projection assembly 6 is projected onto the screen 7. Based on an input signal from an external source, the attitude of the DMD 5 is controlled synchronously with a rotation angle of the color wheel 2. With the configuration described above, a color movie defined by projected images (R images, G images, and B images) changed in high speed is projected onto the screen 7.

In a single-plate type projector unit using DLP described above, the spindle motor is generally arranged such that a rotational axis of the motor is inclined relative to the direction of gravitational force. Thus, in the motor installed in the projector unit, it is more likely that the lubricating oil leaks outside the motor compared with motors used in other applications. When the lubricating oil leaks outside of the housing of the motor, the leaked lubricating oil is likely to remain around the joint portion. The projector unit according to the present preferred embodiment, however, is furnished with the motor described above in which the rotor yoke 13 and the rotor hub 11 are fixed by crimping along the entire circumference and a sealant (e.g., the adhesive) is applied on the joint portion, thus the lubricating oil does not diffuse across the joint portion.

While preferred embodiments of the present invention have been described in the foregoing, the present invention is not limited to the preferred embodiments detailed above, in that various modifications are possible. For example, the rotor yoke maybe welded and fixed to the rotor hub along its entire circumference by radiating a high density energy beam (e.g., a laser beam) such that the joint portion therebetween is securely sealed. To those skilled in the art, it will be apparent from the foregoing disclosure that various changes and modifications can be made herein without departing from the scope of the present invention as defined in the appended claims.

What is claimed is:

1. A motor comprising:
a rotor unit arranged to rotate about a center axis, the rotor unit including:
a rotor hub having a substantially circular shape centered about the center axis;
a shaft concentric with the rotor hub and attached to an approximately middle portion of the rotor hub;
a rotor yoke having a substantially hollow cylindrical shape concentric with the shaft, an entire circumference of an axial end portion of the rotor yoke being crimped to the rotor hub along an outer circumferential portion of the rotor hub; and
a rotor magnet arranged at an inner circumferential surface of the rotor yoke; and
a stator unit rotatably supporting the rotor unit, the stator unit including:
a sleeve having a substantially hollow cylindrical shape concentric with the center axis, the sleeve being impregnated with lubricating oil to rotatably support the shaft; and
a stator arranged to face the rotor magnet.

2. The motor as set forth in claim 1, further comprising a sealant present on an entire circumference where the rotor hub and the rotor yoke are crimped to each other.

3. The motor as set forth in claim 2, wherein the sealant is provided along the entire circumference in a fluid state and then hardened, and the sealant is selected from a group including an adhesive, a resin material, and a paint material.

4. The motor as set forth in claim 3, wherein the sealant is a UV curable adhesive.

5. The motor as set forth in claim 1, wherein the rotor hub and the rotor yoke are welded along the entire circumference of the rotor yoke.

6. The motor as set forth in claim 1, further comprising:
a housing including an inner circumferential surface supporting the sleeve, an outer circumferential surface supporting the stator, and an annular concave portion at which the inner circumferential surface of the housing is radially outwardly recessed; and
an oil supply member arranged in the annular concave portion.

7. The motor as set forth in claim 1, further comprising:
a housing having a substantially hollow cylindrical shape with an upper end opening, a bottom end opening, an inner circumferential surface supporting the sleeve, and an outer circumferential surface supporting the stator;
a cap arranged at a bottom surface of the housing and crimped to the housing to close the bottom end opening of the housing; and
a sealant applied to a portion at which the cap and the housing are crimped.

8. The motor as set forth in claim 1, wherein the rotor hub is made of aluminum.

9. The motor as set forth in claim 1, further comprising:
a housing having a substantially hollow cylindrical shape with an upper end opening, a bottom end opening, an inner circumferential surface supporting the sleeve, and an outer circumferential surface supporting the stator;
a bias magnet arranged at an axial end portion of the stator unit and having an annular shape whose inner circumferential surface faces an outer circumferential surface of the shaft with a gap defined therebetween; and
a ring member made of magnetic material and arranged to axially face the bias magnet.

10. The motor as set forth in claim 1, further comprising:
a housing having a substantially hollow cylindrical shape with an upper end opening, a bottom end opening, an inner circumferential surface supporting the sleeve, and an outer circumferential surface supporting the stator;
a back yoke arranged at an axial end portion of the stator unit and having an annular shape whose inner circumferential surface faces an outer circumferential surface of the shaft with a gap defined therebetween;
a bias magnet having an annular shape and arranged on the back yoke; and
a ring member made of magnetic material and arranged to axially face the bias magnet.

11. The motor as set forth in claim 1, further comprising:
a housing having a substantially hollow cylindrical shape with an upper end opening, a bottom end opening, an inner circumferential surface supporting the sleeve, and an outer circumferential surface supporting the stator;
a ring member made of magnetic material and arranged on the stator unit, the ring member having an inner circumferential surface facing an outer circumferential surface of the shaft with a gap defined therebetween; and
a bias magnet arranged on the rotor unit and axially facing the ring member.

12. The motor as set forth in claim 1, wherein the rotor hub includes a placing surface defined by a substantially flat surface that is substantially perpendicular to the center axis, and a color wheel fixed to the placing surface.

13. A motor including a rotor unit arranged to rotate about a rotational axis and a stator unit rotatably supporting the rotor unit, comprising:
a rotor hub of the rotor unit having a substantially circular shape centered on the rotational axis;
a shaft concentric with the rotor hub and attached to an approximately middle portion of the rotor hub;
a rotor yoke having a substantially hollow cylindrical shape concentric with the shaft, an entire circumference of an axially end portion of the rotor yoke being welded to an outer circumferential portion of the rotor hub;
a rotor magnet arranged at an inner circumferential surface of the rotor yoke;
a sleeve of the stator unit having a substantially hollow cylindrical shape concentric with the rotational axis, and being impregnated with lubricating oil to rotatably support the shaft; and
a stator of the stator unit facing the rotor magnet.

14. The motor as set forth in claim 13, further comprising:
a housing including an inner circumferential surface supporting the sleeve, an outer circumferential surface supporting the stator, and an annular concave portion at which the inner circumferential surface of the housing is radially outwardly recessed; and
an oil supply member arranged in the annular concave portion.

15. The motor as set forth in claim 13, further comprising:
a housing having a substantially hollow cylindrical shape with an upper end opening, a bottom end opening, an inner circumferential surface supporting the sleeve, and an outer circumferential surface supporting the stator;
a cap arranged at a bottom surface of the housing and crimped to the housing to close the bottom end opening of the housing; and
a sealant applied to a portion at which the cap and the housing are crimped.

16. The motor as set forth in claim 13, further comprising:
a housing having a substantially hollow cylindrical shape with an upper end opening, a bottom end opening, an inner circumferential surface supporting the sleeve, and an outer circumferential surface supporting the stator;
a bias magnet arranged at an axial end portion of the stator unit and having an annular shape whose inner circumferential surface faces an outer circumferential surface of the shaft with a gap defined therebetween; and
a ring member made of magnetic material and arranged to axially face the bias magnet.

17. The motor as set forth in claim 13, further comprising:
a housing having a substantially hollow cylindrical shape with an upper end opening, a bottom end opening, an inner circumferential surface supporting the sleeve, and an outer circumferential surface supporting the stator;
a back yoke arranged at an axial end portion of the stator unit and having an annular shape whose inner circumferential surface faces an outer circumferential surface of the shaft with a gap defined therebetween;
a bias magnet having an annular shape and arranged on the back yoke;
a ring member made of magnetic material and arranged to axially face the bias magnet.

18. The motor as set forth in claim 13, further comprising:
a housing having a substantially hollow cylindrical shape with an upper end opening, a bottom end opening, an inner circumferential surface supporting the sleeve, and an outer circumferential surface supporting the stator;
a ring member made of magnetic material and arranged on the stator unit, the ring member having an inner circumferential surface facing an outer circumferential surface of the shaft with a gap defined therebetween; and
a bias magnet arranged on the rotor unit and axially facing the ring member.

19. The motor as set forth in claim 13, wherein the rotor hub includes a placing surface defined by a substantially flat surface that is substantially perpendicular to the rotational axis, and a color wheel fixed to the placing surface.

20. A motor including a rotor unit rotating about a rotational axis and a stator unit rotatably supporting the rotor unit, comprising:
a rotor hub of the rotor unit having a substantially circular shape centered on the rotational axis;
a shaft concentric with the rotor hub and attached to an approximately middle portion of the rotor hub;
a ring member made of magnetic material and arranged on the rotor hub;
a rotor yoke having a substantially hollow cylindrical shape concentric to the shaft, an entire circumference of an axial end portion of the rotor yoke being crimped to an outer circumferential portion of the rotor hub;
a rotor magnet arranged at an inner circumferential surface of the rotor yoke;
a housing of the stator unit having a substantially hollow cylindrical shape with an inner circumferential surface and an outer circumferential surface;
a sleeve rotatably supporting the shaft and having a substantially hollow cylindrical shape concentric with the rotational axis, an outer circumferential surface of the sleeve being fixed to the inner circumferential surface of the housing;
a stator arranged at the outer circumferential surface of the housing and facing the rotor magnet;
a back yoke arranged at a portion of the stator unit near an axial end portion of the sleeve;
a bias magnet having an annular shape arranged on the back yoke and axially facing the ring member; and
a gap defined between the shaft and an inner circumferential surface of at least one of the bias magnet and the back yoke.

21. The motor as set forth in claim 20, wherein the housing includes an annular concave portion at which the inner circumferential surface of the housing is radially outwardly recessed, and an oil supply member is arranged in the annular concave portion.

22. The motor as set forth in claim 20, wherein the housing includes an upper end opening and a bottom end opening, the motor further comprising:
a cap arranged at a bottom surface of the housing and crimped to the housing to close the bottom end opening of the housing; and
a sealant applied to a portion at which the cap is crimped to the housing.

23. The motor as set forth in claim 20, wherein the rotor hub includes a placing surface defined by a substantially flat surface that is substantially perpendicular to the rotational axis, and a color wheel fixed to the placing surface.

24. A display unit comprising:
a color wheel assembly including a rotary color wheel having color filters on a circular disk and arranged to project and display a color picture image, and a motor according to claim 1 arranged to drive the color wheel; and
a light source arranged to emit light toward the color wheel;
a digital micro mirror device arranged to reflect light transmitted through the color wheel by movable mirrors;
a projection optical system arranged to project the light reflected from the digital micro mirror device onto a screen; and
a case arranged to house the color wheel assembly, the light source, the digital micro mirror device, and the projection optical system.

25. A display unit comprising:
a color wheel assembly including a rotary color wheel having color filters on a circular disk and arranged to project and display a color picture image, and a motor according to claim 13 arranged to drive the color wheel;
a light source arranged to emit light toward the color wheel;
a digital micro mirror device arranged to reflect light transmitted through the color wheel by movable mirrors;
a projection optical system arranged to project the light reflected from the digital micro mirror device onto a screen; and
a case arranged to house the color wheel assembly, the light source, the digital micro mirror device, and the projection optical system.

26. A display unit comprising:
a color wheel assembly including a rotary color wheel having color filters on a circular disk and arranged to project and display a color picture image, and a motor according to claim 20 arranged to drive the color wheel;
a light source arranged to emit light toward the color wheel;
a digital micro mirror device arranged to reflect light transmitted through the color wheel by movable mirrors;
a projection optical system arranged to project the light reflected from the digital micro mirror device onto a screen; and
a case arranged to house the color wheel assembly, the light source, the digital micro mirror device, and the projection optical system.
